(19) United States
(12) Patent Application Publication
(10) Pub. No.: US 2013/0324150 A1
(43) Pub. Date: Dec. 5, 2013

(54) LOCATION ESTIMATION APPARATUS AND METHOD

(71) Applicant: Electronics and Telecommunications Research Institute, (US)

(72) Inventors: Seong-Yun CHO, Daejeon (KR); Joo-Young Kim, Daejeon (KR)

(73) Assignee: Electronics and Telecommunications Research Institute, Daejeon-city (KR)

(21) Appl. No.: 13/775,652

(22) Filed: Feb. 25, 2013

(30) Foreign Application Priority Data
Jun. 5, 2012 (KR) 10-2012-0060312

(51) Int. Cl. H04W 24/00

(52) U.S. Cl. CPC H04W 24/00
USPC 455/456.1

(57) ABSTRACT

Disclosed herein is a location estimation apparatus and method. The location estimation apparatus according to the present invention includes a setting unit for setting a coordinate system based on location information. A selection unit selects a target node, a location of which is to be estimated, based on connection information between nodes received from a plurality of nodes constituting a network. An estimation unit estimates location information of the target node depending on a connection relationship between the target node and reference nodes, location information of which is known.

### CROSS REFERENCE TO RELATED APPLICATION

This application claims the benefit of Korean Patent Application No. 10-2012-0060312, filed on Jun. 5, 2012, which is hereby incorporated by reference in its entirety into this application.

### BACKGROUND OF THE INVENTION

1. Technical Field

The present invention relates generally to a location estimation apparatus and method and, more particularly, to a location estimation apparatus and method, which estimate the location of a target node in an environment including a plurality of nodes.

2. Description of the Related Art

Location estimation technology is core technology for providing various types of services in environments such as traffic, the military, distribution, logistics, and home networks. Location estimation technology can be classified as Global Positioning System (GPS)-based location estimation technology and Wireless Personal Area Network (WPAN)-based location estimation technology.

The GPS-based location estimation technology widely used in traffic and military fields can take measurements over a wide area, but is problematic in that it is impossible to estimate locations in an area in which a clear view is not secured, such as a tunnel or an indoor area, and estimation accuracy is low. In order to solve this problem, research into the estimation of the location of a target node in indoor and shadow areas has been actively conducted, and representative technologies include Wireless Fidelity (Wi-Fi), Zigbee, Bluetooth, Radio Frequency Identification (RFID), etc. Location awareness technology using Wi-Fi, Zigbee, Bluetooth, or RFID is technology that operates at low power, but is problematic in that it has low accuracy and has difficulty tracking the trajectory of a target node in motion.

In order to solve this problem, an IEEE 802.15.4a tasking group settled standards for new technology that is based on low-speed wireless communication and is capable of estimating locations with lower power and high accuracy. These standards selected an Impulse Radio (IR) group that uses an Ultra-Wide Band (UWB), and a Chirp Spread Spectrum (CSS) group that uses an Industrial Scientific Medical (ISM) frequency band.

However, the UWB-based location estimation technology and the CSS-based location estimation technology are problematic in that a fixed anchor node is required so as to estimate the location of a target node, thus making it impossible to accurately estimate the location of the target node in an environment in which the anchor node is not present.

Further, UWB-based location estimation technology and CSS-based location estimation technology use a reference node, the location information of which is known, to estimate the location of the target node. In this case, a problem arises in that an error occurs due to a difference between timers (clocks) used in the target node and reference nodes and the location of the target node cannot be accurately estimated due to the error.

Furthermore, there is a problem in that when the target node is moving, such movement causes an error, thus making it impossible to accurately estimate the location of the target node due to such an error.

Korean Patent No. 10-0583401 discloses a local area wireless location determination system and method for single transmission/reception mode. However, technology disclosed in this patent can be applied only to an environment in which an anchor node is present.

Therefore, new technology for estimating the location of a target node in an environment in which an anchor node is not present is urgently required.

### SUMMARY OF THE INVENTION

Accordingly, the present invention has been made keeping in mind the above problems occurring in the prior art, and an object of the present invention is to provide a location estimation apparatus, which estimates the location of a target node in an environment in which a fixed anchor node is not present.

Another object of the present invention is to provide a location estimation method, which estimates the location of a target node in an environment in which a fixed anchor node is not present.

In accordance with an aspect of the present invention to accomplish the above objects, there is provided a location estimation apparatus including a setting unit for setting a coordinate system based on location information, a selection unit for selecting a target node, a location of which is to be estimated, based on connection information between nodes received from a plurality of nodes constituting a network, and an estimation unit for estimating location information of the target node depending on a connection relationship between the target node and reference nodes, location information of which is known.

Preferably, the setting unit may set the coordinate system based on the location information as a reference point, correct the coordinate system so that at least one of the nodes constituting the network is located on one axis of the coordinate system, and estimate location information of the at least one node by estimating a distance between the reference point and the at least one node.

Preferably, the selection unit may select, as the target node, a node connected to a largest number of reference nodes from among the nodes constituting the network.

Preferably, the estimation unit may be configured such that when two reference nodes are connected to the target node, if it is determined that a sum of a distance between the target node and one reference node and a distance between the target node and a remaining reference node is less than a distance between the one reference node and the remaining reference node, an average value of location information of the one reference node and location information of the remaining reference node is estimated as location information of the target node.

Preferably, the estimation unit may be configured to, when three or more reference nodes are connected to the target node, estimate location information of the target node based on pieces of location information of the reference nodes connected to the target node, generate residual information based on a difference between the estimated location information of the target node and the location information of the reference nodes connected to the target node, and re-estimate location information of the target node or confirm the estimated location information of the target node as final location information, depending on results of a comparison between the residual information and a preset reference value.

Preferably, the estimation unit may be configured to, if the residual information is greater than the preset reference value, re-estimate the location information of the target node based on location information, except for oldest location information, among the pieces of location information of the reference nodes connected to the target node, and if the residual information is equal to or less than the preset reference value, confirm the estimated location information of the target node as the final location information.

In accordance with another aspect of the present invention to accomplish the above objects, there is provided a location estimation method, the method being performed by an arbitrary node of a plurality of nodes constituting a network, including setting a coordinate system based on a location of the arbitrary node, receiving connection information between nodes from the plurality of nodes constituting the network, selecting a target node, a location of which is to be estimated, based on the connection information, and estimating location information of the target node depending on a connection relationship between the target node and reference nodes, location information of which is known.

Preferably, the setting the coordinate system based on the location of the arbitrary node may include setting the coordinate system based on the location of the arbitrary node as a reference point, correcting the coordinate system so that at least one of the nodes constituting the network is located on one axis of the coordinate system, and estimating location information of the at least one node by estimating a distance between the reference point and the at least one node.

Preferably, the selecting the target node, the location of which is to be estimated, based on the connection information may be configured to select, as the target node, a node connected to a largest number of reference nodes from among the nodes constituting the network.

Preferably, the estimating the location information of the target node depending on the connection relationship between the target node and reference nodes may be configured such that, when two reference nodes are connected to the target node, if it is determined that a sum of a distance between the target node and one reference node and a distance between the target node and a remaining reference node is less than a distance between the one reference node and the remaining reference node, an average value of location information of the one reference node and location information of the remaining reference node is estimated as location information of the target node.

Preferably, the estimating the location information of the target node depending on the connection relationship between the target node and reference nodes may include, when three or more reference nodes are connected to the target node, estimating location information of the target node based on pieces of location information of the reference nodes connected to the target node, generating residual information based on a difference between the estimated location information of the target node and the location information of the reference nodes connected to the target node, and re-estimating location information of the target node or confirming the estimated location information of the target node as final location information, depending on results of a comparison between the residual information and a preset reference value.

Preferably, the re-estimating location information of the target node or the confirming the estimated location information of the target node as final location information depending on results of a comparison between the residual information and a preset reference value may include, if the residual information is greater than the preset reference value, re-estimating the location information of the target node based on location information, except for oldest location information, among the pieces of location information of the reference nodes connected to the target node, and if the residual information is equal to or less than the preset reference value, confirming the estimated location information of the target node as the final location information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a location estimation apparatus according to an embodiment of the present invention;

FIG. 2 is a conceptual diagram showing a coordinate system according to an embodiment of the present invention;

FIG. 3 is a conceptual diagram showing the distribution of reference nodes constituting a network;

FIG. 4 is a conceptual diagram showing the distribution of reference nodes and a target node constituting a network;

FIG. 5 is an operating flowchart showing a location estimation method according to an embodiment of the present invention; and

FIG. 6 is an operating flowchart showing in detail the step of estimating the location information of a target node, shown in FIG. 5.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, preferred embodiments of the present invention will be described in detail with reference to the attached drawings.

Throughout the entire specification, the term “network” denotes a network that may be composed of a plurality of nodes capable of performing communication. The term “reference node” denotes a node that is capable of communicating with other nodes, knows its location information, and is capable of performing the function of measuring the distance to a target node, the location of which is to be estimated. The term “target node” denotes a node that is capable of communicating with other nodes, does not know its location information, and is capable of performing the function of measuring the distance to the reference node. The term “location information” may include information about the coordinates of a node located in a coordinate system and the distance to another node.

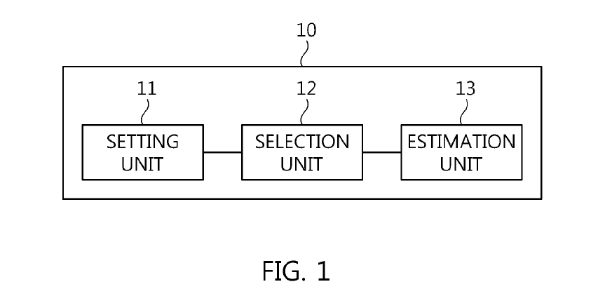

FIG. 1 is a block diagram showing a location estimation apparatus according to an embodiment of the present invention.

Referring to FIG. 1, a location estimation apparatus 10 according to an embodiment of the present invention includes a setting unit 11, a selection unit 12, and an estimation unit 13. Here, the location estimation apparatus 10 may refer to an arbitrary node of nodes constituting a network.

The setting unit 11 may set a coordinate system based on location information. In this case, the setting unit 11 can use its location information, that is, the location of the location estimation apparatus 10, as the location information. The setting unit 11 can set a two-dimensional (2D) coordinate system or a three-dimensional (3D) coordinate system based on the location of the location estimation apparatus 10 as a reference point. Here, the 2D coordinate system can be composed of an x axis and a y axis, which can be located perpendicularly to each other. Further, the location of a node located in the 2D coordinate system can be represented by (x, y). The 3D coordinate system can be composed of an x axis, a y axis, and a z axis, which can be located perpendicularly to one another. Furthermore, the location of a node located in the 3D coordinate system can be represented by (x, y, z).

When it is desired to set the 2D coordinate system, the setting unit 11 can set the 2D coordinate system by defining the location of the location estimation apparatus 10 that is the reference point as (0, 0), and can also set the 2D coordinate system by defining the location of the location estimation apparatus 10 that is the reference point as (0.001, 0.001). When it is desired to set the 3D coordinate system, the setting unit 11 can set the 3D coordinate system by defining the location of the location estimation apparatus 10 that is the reference point as (0, 0, 0), and can also set the 3D coordinate system by defining the location of the location estimation apparatus 10 that is the reference point as (0.001, 0.001, 0.001). That is, the coordinates of the location estimation apparatus 10 that is the reference point upon setting the coordinate system vary depending on the settings of a user. Here, ‘m’ may be used as the unit of the coordinate system, and coordinates (0.001. 0.001) may mean that the node is located at a position of 0.001 m along the direction of an X axis and of 0.001 m along the direction of a Y axis.

After setting the coordinate system, the setting unit 11 can correct the coordinate system so that at least one of nodes constituting the network is located on one of the axes of the coordinate system. For example, when the setting unit 11 sets the 2D coordinate system, the coordinate system can be corrected such that at least one node is located on the x axis, or such that at least one node is located on the y axis. In this case, the node located on one of the axes of the coordinate system is a node located within the range of the location estimation apparatus 10, that is, a node located within the range of enabling communication with the location estimation apparatus 10. Here, the node located within the range of enabling communication with the location estimation apparatus 10 denotes a node that can be connected (or linked) to the location estimation apparatus 10 via communication.

After the coordinate system has been corrected such that at least one node is located on one axis of the coordinate system, the setting unit 11 can estimate the location information of the node located on one axis of the coordinate system. The setting unit 11 can estimate the distance from the location estimation apparatus 10 to the node located on the one axis of the coordinate system while communicating with the node, and estimate the location information of the node located on the one axis of the coordinate system using the estimated distance. In this case, the setting unit 11 can estimate the distance from the location estimation apparatus 10 to the node located on the one axis of the coordinate system by using Time Of Arrival (TOA), a Time Difference Of Arrival (TDOA), a two-way distance measurement (two-way ranging) method, or the like.

$${P}_{BT} = [ \begin{matrix}{ρ}_{M - BT} \\ 0.001\end{matrix} ] \qquad ( 1 )$$

In Equation (1), P_{ET} denotes the location information of the node located on the one axis of the coordinate system, ρ_{M-BT} denotes the distance from the location estimation apparatus 10 to the node located on the one axis of the coordinate system, and 0.001 denotes the y axis coordinate of the location estimation apparatus 10. That is, the location information of the node located on the x axis can be estimated using Equation (1).

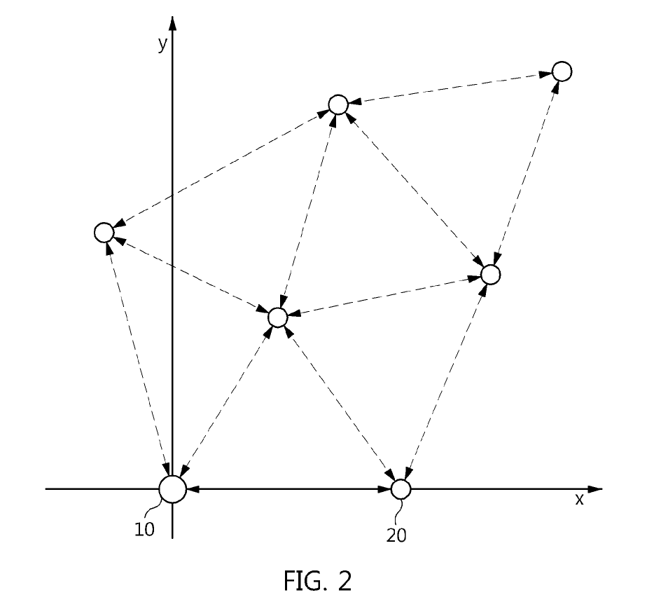

FIG. 2 is a conceptual diagram showing a coordinate system according to an embodiment of the present invention.

Referring to FIG. 2, a plurality of nodes 10 and 20 are located in a 2D coordinate system, an arbitrary node of the plurality of nodes can be regarded as the location estimation apparatus 10, and nodes connected by a dotted line can be regarded as being connected to one another. That is, a node connected to a specific node by a dotted line can be regarded as being located within the range of enabling communication with the specific node. Here, the location estimation apparatus 10 is located at the reference point of the 2D coordinate system, and a single node 20 is located on the x axis. In this case, the location of the location estimation apparatus 10 is either (0, 0) or (0.001, 0.001).

The selection unit 12 can select a target node, the location of which is to be estimated, based on connection information between nodes, received from the plurality of nodes constituting the network The term “connection information between nodes” includes the number of nodes located within the range of enabling communication with the specific node and the characteristic information of the nodes located within the communication-enabled range. The characteristic information of each node denotes information indicating whether the node is a reference node which knows its location, or a node which does not know its location.

The selection unit 12 measures the number of reference nodes located within the communication ranges of the nodes constituting the network based on the connection information, and can select a node having a communication range in which a largest number of reference nodes are located as the target node.

In this case, the selection unit 12 can continuously update the number of nodes located within the range of enabling communication with the specific node and the characteristic information of the nodes located within the communication-enabled range, based on the connection information received periodically or non-periodically from the plurality of nodes constituting the network.

The estimation unit 13 can estimate the location information of the target node depending on a connection relationship between the target node and reference nodes. That is, the estimation unit 13 can estimate the location information of the target node by applying different methods depending on the number of reference nodes located within the communication range of the target node.

When the number of reference nodes located within the communication range of the target node is 2 (that is, when the number of reference nodes connected to the target node is 2), the estimation unit 13 can estimate the location information of the target node, based on the results of a comparison between the sum of the distance between the target node and one reference node and the distance between the target node and the other reference node, and the distance between the one reference node and the other reference node.

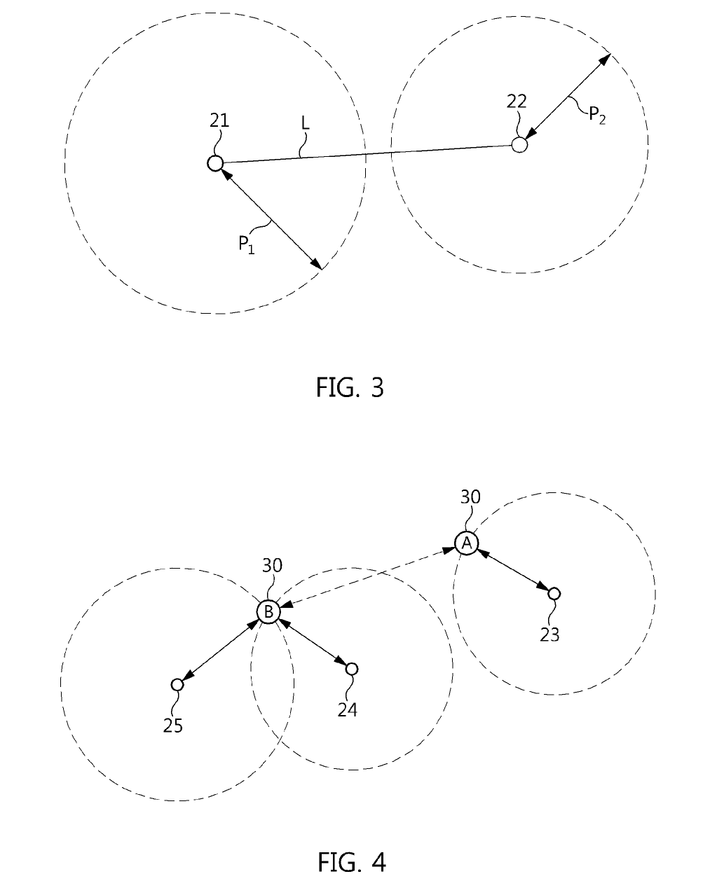

FIG. 3 is a conceptual diagram showing the distribution of reference nodes constituting a network.

Referring to FIG. 3, a method of estimating the location information of a target node when the number of reference nodes located within the communication range of a target node is 2 will be described in detail.

When there are two reference nodes 21 and 22 located within the communication range of the target node, the two reference nodes 21 and 22 can estimate distances to the target node while communicating with the target node. One reference node 21 and the other reference node 22 can estimate the distance therebetween via communication. ‘P₁’ denotes the distance to the target node estimated by the one reference node 21, ‘P₂’ denotes the distance to the target node estimated by the other reference node 22, and ‘L’ denotes the distance from the one reference node 21 to the other reference node 22.

Generally, when the number of reference nodes 21 and 22 located within the communication range of the target node is 2, a virtual circle having a radius of P₁ and a virtual circle having a radius of P₂ intersect at at least one location. In this case, when the virtual circle having a radius of P₁ and the virtual circle having a radius of P₂ intersect at one location, that location can be estimated as the location information of the corresponding target node. When the virtual circle having a radius of P₁ and the virtual circle having a radius of P₂ intersect at two locations, one of the two locations can be estimated as the location information of the corresponding target node. In this regard, when one of the two locations is estimated as the location information of the corresponding target node, the location information of the target node can be estimated based on the connection information of other nodes.

Meanwhile, when two reference nodes 21 and 22 are located within the communication range of the target node, but there is no location at which the virtual circle having a radius of P₁ and the virtual circle having a radius of P₂ intersect, L>P₁+P₂ may occur. This case may occur due to an error between the timers (clocks) of the nodes. When L is greater than P₁+P₂, the estimation unit 13 can estimate an average value of the location information of the one reference node 21 and the location information of the other reference node 22 as the location information of the target node.

$${P}_{TR} = \frac{{P}_{NR 1} + {P}_{NR 2}}{2} \qquad ( 2 )$$

In Equation (2), P_{TR} denotes the location information of the target node, P_{NR1} denotes the location information of the one reference node 21, and P_{NR2} denotes the location information of the other reference node 22. That is, even if the virtual circle having a radius of P₁ and the virtual circle having a radius of P₂ do not intersect at any location, the location information of the target node can be estimated by Equation (2).

When the number of reference nodes located within the communication range of the target node is 3 or more (that is, the number of reference nodes connected to the target node is 3), the estimation unit 13 can estimate the location information of the target node based on the location information of the reference nodes located within the communication range of the target node. In this case, the estimation unit 13 can estimate the location information of the target node using triangulation. Here, the estimated location information of the target node is one of candidates for final location information rather than the final location information.

After the location information of the target node has been estimated, the estimation unit 13 can generate residual information based on a difference between the estimated location information of the target node and the location information of the reference nodes located within the communication range of the target node.

$$R = \sqrt{\frac{1}{n} {\sum }_{i = 1}^{n} {( \sqrt{{( {x}_{i} - {x}_{T} )}^{2} + {( {y}_{i} - {y}_{T} )}^{2}} - {ρ}_{i} )}^{2}} \qquad ( 3 )$$

In Equation (3), R denotes residual information, n denotes the number of reference nodes located within the communication range of the target node, xᵢ and yᵢ denote the location information of an i-th reference node, x_{T} and y_{T} denote the location information of the target node estimated by the estimation unit 13, and ρᵢ denotes the distance from the i-th reference node to the target node. By using Equation (3), residual information that is the difference between the location information of the target node and the location information of the reference nodes located within the communication range of the target node can be generated.

The estimation unit 13 may re-estimate the location information of the target node or confirm the estimated location information of the target node as final location information, depending on the results of a comparison between the residual information and a preset reference value. Here, the reference value is a value that is a reference used to determine whether the location information of the target node estimated by the estimation unit 13 has been accurately estimated. Here, if the residual information is equal to or less than the reference value, it can be determined that the location information of the target node has been accurately estimated. In contrast, if the residual information is greater than the reference value, it can be determined that the location information of the target node has not been accurately estimated. That is, as the target node is moving, the number of reference nodes located within the communication range of the target node changes. When such information is not updated, the residual information may be greater than the reference value.

FIG. 4 is a conceptual diagram showing the distribution of reference nodes and a target node constituting a network.

The case where residual information becomes greater than a reference value will be described in detail with reference to FIG. 4. A target node 30 moves from ‘A’ to ‘B’, and is located within the communication range of a reference node 23 when the target node 30 is located at ‘A’. Therefore, the reference node 23 estimates information about the distance to the target node 30, and provides the distance information to the location estimation apparatus 10 (see FIG. 1).

Thereafter, when the target node 30 moves to ‘B’, the target node 30 is located within the communication range of reference nodes 24 and 25. Accordingly, the reference nodes 24 and 25 estimate information about the distances to the target node 30, and provide the distance information to the location estimation apparatus 10. In this case, since the target node 30 which was located at ‘A’ moves to ‘B’, the reference node 23 must notify the location estimation apparatus 10 that the target node 30 is not located in its communication range. However, when the reference node 23 does not or cannot notify the location estimation apparatus 10 of the fact, the location estimation apparatus 10 recognizes that the target node 30 stays in the communication range of the reference nodes 23, 24, and 25.

In this case, the location estimation apparatus 10 must estimate the location information of the target node using the location information of only the reference nodes 24 and 25, but estimates the location information of the target node using the location information of the reference nodes 23, 24, and 25, thus making it difficult to accurately estimate the location information of the target node. Consequently, residual information generated in the above case will have a value greater than the reference value.

As a result of the comparison between the residual information and the reference value, if it is determined that the residual information is equal to or less than the reference value, the estimation unit 13 can confirm the location information of the target node, estimated based on the location information of the reference nodes, as final location information.

As a result of the comparison between the residual information and the reference value, if it is determined that the residual information is greater than the reference value (that is, the above-described case of FIG. 4), the location information of the target node can be re-estimated using the location information of reference nodes, except for a reference node having the oldest location information among reference nodes located within the communication range of the target node.

In this case, when two reference nodes remain with the exception of the reference node having the oldest location information, the location information of the target node can be estimated by the above-described method of estimating the location information of the target node using the location information of two reference nodes. Meanwhile, when three or more reference nodes remain with the exception of the reference node having the oldest location information, the location information of the target node can be estimated by the above-described method of estimating the location information of the target node using the location information of three or more reference nodes.

In the present invention, the setting unit 11, the selection unit 12, and the estimation unit 13 are exemplified as independent parts, but they may be implemented as a single form, a single physical device or a single module. In addition, each of the setting unit 11, the selection unit 12, and the estimation unit 13 may be implemented using a plurality of physical devices or groups rather than a single physical device or group.

In the above description, the location estimation apparatus according to the embodiment of the present invention has been described in detail. Below, a location estimation method according to an embodiment of the present invention will be described in detail.

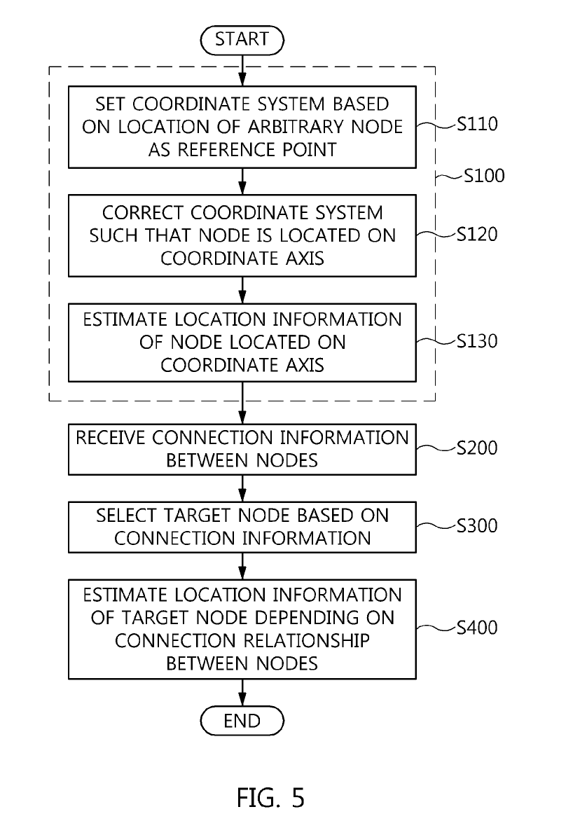

FIG. 5 is an operating flowchart showing a location estimation method according to an embodiment of the present invention.

Referring to FIG. 5, the location estimation method includes the step S100 of setting a coordinate system based on the location of an arbitrary node, the step S200 of receiving connection information between nodes constituting a network from the nodes, the step S300 of selecting a target node, the location of which is to be estimated, based on the connection information, and the step S400 of estimating the location information of the target node depending on a connection relationship between the target node and reference nodes, the location information of which is known. In this case, the location estimation method may be performed by the location estimation apparatus 10 (see FIG. 1), and the location estimation apparatus may be an arbitrary node of nodes constituting the network.

The location estimation apparatus can set the coordinate system based on its location information at step S110. In this case, the location estimation apparatus can set a 2D coordinate system or a 3D coordinate system based on its location as a reference point. Here, the 2D coordinate system can be composed of an x axis and a y axis, which can be located perpendicularly to each other. Further, the location of a node located in the 2D coordinate system can be represented by (x, y). The 3D coordinate system can be composed of an x axis, a y axis, and a z axis, which can be located perpendicularly to one another. Furthermore, the location of a node located in the 3D coordinate system can be represented by (x, y, z).

When it is desired to set the 2D coordinate system, the location estimation apparatus can set the 2D coordinate system by defining its location as (0, 0), and can also set the 2D coordinate system by defining its location as (0.001, 0.001). When it is desired to set the 3D coordinate system, the location estimation apparatus can set the 3D coordinate system by defining its location as (0, 0, 0), and can also set the 3D coordinate system by defining its location as (0.001, 0.001, 0.001). That is, the coordinates of the location estimation apparatus that is the reference point upon setting the coordinate system vary depending on the settings of a user. Here, ‘m’ may be used as the unit of the coordinate system, and coordinates (0.001. 0.001) may mean that a node is located at a position of 0.001 m along the direction of an X axis and of 0.001 m along the direction of a Y axis.

After setting the coordinate system, the location estimation apparatus can correct the coordinate system so that at least one of nodes constituting the network is located on one axis of the coordinate system at step S120. For example, when the location estimation apparatus sets the 2D coordinate system, the coordinate system can be corrected so that at least one node is located on the x axis, or so that at least one node is located on the y axis. In this case, the node located on the one axis of the coordinate system is a node located within the range of the location estimation apparatus, that is, a node located within the range of enabling communication with the location estimation apparatus.

After the coordinate system has been corrected so that at least one node is located on the one axis of the coordinate system, the location estimation apparatus can estimate the location information of the node located on the one axis of the coordinate system at step S130. The location estimation apparatus can estimate the distance to the node located on the one axis of the coordinate system while communicating with the node, and estimate the location information of the node located on the one axis of the coordinate system using the estimated distance. In this case, the location estimation apparatus can estimate the distance from the location estimation apparatus to the node located on the one axis of the coordinate system by using Time Of Arrival (TOA), a Time Difference Of Arrival (TDOA), a two-way ranging method, or the like. The location estimation apparatus can estimate the location information of the node using the above Equation (1). In Equation (1), P_{BT} denotes the location information of the node located on the one axis of the coordinate system, ρ_{M-BT} denotes the distance from the location estimation apparatus to the node located on the one axis of the coordinate system, and 0.001 denotes the y axis coordinate of the location estimation apparatus.

The location estimation apparatus can receive connection information between the nodes constituting the network from the nodes at step S200. The location estimation apparatus may perform step S200 after or before performing step S100. Here, the connection information between the nodes includes the number of nodes located within the range of enabling communication with a specific node and characteristic information of the nodes located within the communication-enabled range. The characteristic information of each node denotes information indicating whether the node is a reference node which knows its location, or a node which does not know its location. The location estimation apparatus can periodically or non-periodically receive connection information between the nodes, and update the number of nodes located within the range of enabling communication with the specific node and the characteristic information of the nodes located within the communication-enabled range.

After receiving the connection information between the nodes, the location estimation apparatus can select a target node, the location of which is to be estimated, based on the connection information between the nodes at step S300. The location estimation apparatus can measure the number of reference nodes located within the communication ranges of nodes constituting the network (that is, the number of reference nodes connected (linked) to each node) based on the connection information, and can select a node having a communication range, in which a largest number of reference nodes are located, as the target node.

After selecting the target node based on the connection information, the location estimation apparatus can estimate the location information of the target node at step S400.

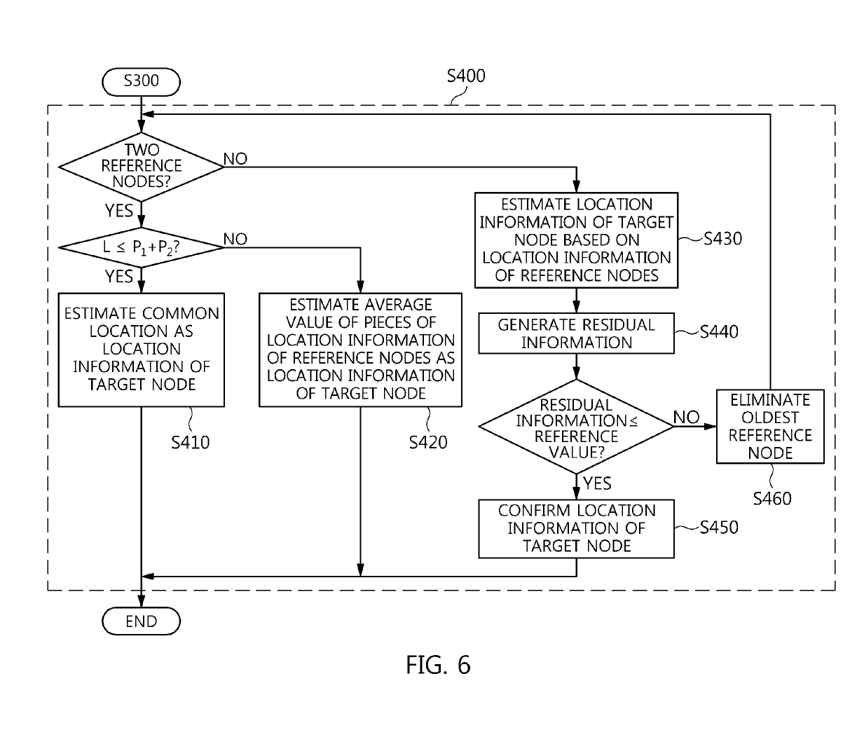

FIG. 6 is an operating flowchart showing in detail the step of estimating the location information of the target node shown in FIG. 5.

Referring to FIG. 6, the location estimation apparatus can estimate the location information of the target node depending on the number of reference nodes located within the communication range of the target node.

If it is determined that two reference nodes are located within the communication range of the target node (that is, the case where the number of reference nodes connected to the target node is 2), the location estimation apparatus can estimate the location information of the target node depending on the results of a comparison between the magnitudes of ‘L’ (the distance between one reference node 21 and the other reference node 22, see FIG. 3) and ‘P₁+P₂’ (where ‘P₁’ denotes the distance to the target node estimated by the one reference node 21 and ‘P₂’ denotes the distance to the target node estimated by the other reference node 22, see FIG. 3).

For example, when ‘L=P₁+P₂’ (when a virtual circle having a radius of P₁ and a virtual circle having a radius of P₂ intersect at one location), the location estimation apparatus can estimate the location, at which the virtual circle having a radius of P₁ and the virtual circle having a radius of P₂ intersect, as the location information of the target node at step S410.

When ‘L<P₁+P₂’ (when the virtual circle having a radius of P₁ and the virtual circle having a radius of P₂ intersect at two locations), the location estimation apparatus can estimate one of the locations, at which the virtual circle having a radius of P₁ and the virtual circle having a radius of P₂ intersect, as the location information of the target node at step S401. Here, when one of the two locations is estimated as the location information of the target node, the location estimation apparatus can estimate the location information of the target node based on the connection information of other nodes.

when ‘L>P₁+P₂’ (when the virtual circle having a radius of P₁ and the virtual circle having a radius of P₂ do not intersect each other), the location estimation apparatus can estimate an average value of the location information of the one reference node and the location information of the other reference node as the location information of the target node at step S420. In this case, the location estimation apparatus can estimate the location information of the target node using the above Equation (2). In Equation (2), P_{TR} denotes the location information of the target node, P_{NR1} denotes the location information of the one reference node, and P_{NR2} denotes the location information of the other reference node.

If it is determined that three or more reference nodes are located within the communication range of the target node (the case when the number of reference nodes connected to the target node is 3), the location estimation apparatus can estimate the location information of the target node, based on the location information of the reference nodes located within the communication range of the target node at step S430. In this case, the location estimation apparatus can estimate the location information of the target node using triangulation. Here, the location information of the target node estimated at step S430 is one of candidates for final location information rather than the final location information.

After estimating the location information of the target node, the location estimation apparatus can generate residual information based on the difference between the estimated location information of the target node and the location information of the reference nodes located within the communication range of the target node at step S440. In this case, the location estimation apparatus can generate residual information using the above Equation (3). In Equation (3), R denotes residual information, n denotes the number of reference nodes located within the communication range of the target node, xᵢ and yᵢ denote the location information of an i-th reference node, x_{T} and y_{T} denote the location information of the target node estimated by the location estimation apparatus, and ρᵢ denotes the distance from the i-th reference node to the target node.

After generating the residual information, the location estimation apparatus can re-estimate the location information of the target node or confirm the estimated location information of the target node as final location information, depending on the results of a comparison between the residual information and a preset reference value. Here, the reference value is a value that is a reference used to determine whether the location information of the target node estimated by the location estimation apparatus has been accurately estimated. In this regard, if the residual information is equal to or less than the reference value, it can be determined that the location information of the target node has been accurately estimated. In contrast, if the residual information is greater than the reference value, it can be determined that the location information of the target node has not been accurately estimated. That is, as the target node is moving, the number of reference nodes located within the communication range of the target node changes. When such information is not updated, the residual information may become greater than the reference value (in the case of FIG. 4).

As a result of the comparison between the residual information and the reference value, if it is determined that the residual information is equal to or less than the reference value, the location estimation apparatus can confirm the location information of the target node estimated at step S430 as the final location information at step S450.

As a result of the comparison between the residual information and the reference value, if it is determined that the residual information is greater than the reference value (that is, the case of FIG. 4), the location estimation apparatus excludes a reference node having the oldest location information from the reference nodes located within the communication range of the target node at step S460, and can re-estimate the location information of the target node using the location information of the remaining reference nodes.

In this case, when two reference nodes remain with the exception of the reference node having the oldest location information, the location information of the target node can be estimated by the above-described method (S410 and S420) of estimating the location information of the target node using the location information of two reference nodes. Meanwhile, when three or more reference nodes remain with the exception of the reference node having the oldest location information, the location information of the target node can be estimated by the above-described method (S430, S440, S450, and S460) of estimating the location information of the target node using the location information of three or more reference nodes.

According to the present invention, upon estimating the location of a target node in a network environment including a plurality of nodes, the location of a target node can be accurately estimated even if a fixed anchor node is not present.

Further, the present invention can more accurately estimate the location of a target node because an error caused by a difference between timers (clocks) used in the target node and reference nodes can be corrected.

Furthermore, the present invention can more accurately estimate the location of a target node because an error caused by the movement of the target node can be corrected.

As described above, in the location estimation apparatus and method according to the present invention, the configurations and schemes in the above-described embodiments are not limitedly applied, and some or all of the above embodiments can be selectively combined and configured so that various modifications are possible.

What is claimed is:

1. A location estimation apparatus comprising:
a setting unit for setting a coordinate system based on location information;
a selection unit for selecting a target node, a location of which is to be estimated, based on connection information between nodes, the connection information received from a plurality of nodes constituting a network; and
an estimation unit for estimating location information of the target node depending on a connection relationship between the target node and reference nodes, location information of which is known.

2. The location estimation apparatus of claim 1, wherein the setting unit sets the coordinate system based on the location information as a reference point, corrects the coordinate system so that at least one of the nodes constituting the network is located on one axis of the coordinate system, and estimates location information of the at least one node by estimating a distance between the reference point and the at least one node.

3. The location estimation apparatus of claim 1, wherein the selection unit selects, as the target node, a node connected to a largest number of reference nodes from among the nodes constituting the network.

4. The location estimation apparatus of claim 1, wherein the estimation unit is configured such that when two reference nodes are connected to the target node,
if it is determined that a sum of a distance between the target node and one reference node and a distance between the target node and a remaining reference node is less than a distance between the one reference node and the remaining reference node, an average value of location information of the one reference node and location information of the remaining reference node is estimated as location information of the target node.

5. The location estimation apparatus of claim 1, wherein the estimation unit is configured to, when three or more reference nodes are connected to the target node,
estimate location information of the target node based on pieces of location information of the reference nodes connected to the target node, generate residual information based on a difference between the estimated location information of the target node and the location information of the reference nodes connected to the target node, and re-estimate location information of the target node or confirm the estimated location information of the target node as final location information, depending on results of a comparison between the residual information and a preset reference value.

6. The location estimation apparatus of claim 5, wherein the estimation unit is configured to,
if the residual information is greater than the preset reference value, re-estimate the location information of the target node based on location information, except for oldest location information, among the pieces of location information of the reference nodes connected to the target node, and
if the residual information is equal to or less than the preset reference value, confirm the estimated location information of the target node as the final location information.

7. A location estimation method, the method being performed by an arbitrary node of a plurality of nodes constituting a network, comprising:
setting a coordinate system based on a location of the arbitrary node;
receiving connection information between nodes from the plurality of nodes constituting the network;
selecting a target node, a location of which is to be estimated, based on the connection information; and
estimating location information of the target node depending on a connection relationship between the target node and reference nodes, location information of which is known.

8. The location estimation method of claim 7, wherein the setting the coordinate system based on the location of the arbitrary node comprises:
setting the coordinate system based on the location of the arbitrary node as a reference point;
correcting the coordinate system so that at least one of the nodes constituting the network is located on one axis of the coordinate system; and
estimating location information of the at least one node by estimating a distance between the reference point and the at least one node.

9. The location estimation method of claim 7, wherein the selecting the target node, the location of which is to be estimated, based on the connection information is configured to select, as the target node, a node connected to a largest number of reference nodes from among the nodes constituting the network.

10. The location estimation method of claim 7, wherein the estimating the location information of the target node depending on the connection relationship between the target node and reference nodes is configured such that, when two reference nodes are connected to the target node,
if it is determined that a sum of a distance between the target node and one reference node and a distance between the target node and a remaining reference node is less than a distance between the one reference node and the remaining reference node, an average value of location information of the one reference node and location information of the remaining reference node is estimated as location information of the target node.

11. The location estimation method of claim 7, wherein the estimating the location information of the target node depending on the connection relationship between the target node and reference nodes comprises, when three or more reference nodes are connected to the target node:
estimating location information of the target node based on pieces of location information of the reference nodes connected to the target node;
generating residual information based on a difference between the estimated location information of the target node and the location information of the reference nodes connected to the target node; and
re-estimating location information of the target node or confirming the estimated location information of the target node as final location information, depending on results of a comparison between the residual information and a preset reference value.

12. The location estimation method of claim 11, wherein the re-estimating location information of the target node or the confirming the estimated location information of the target node as final location information depending on results of a comparison between the residual information and a preset reference value comprises:
if the residual information is greater than the preset reference value, re-estimating the location information of the target node based on location information, except for oldest location information, among the pieces of location information of the reference nodes connected to the target node; and
if the residual information is equal to or less than the preset reference value, confirming the estimated location information of the target node as the final location information.
